(19) United States
(12) Patent Application Publication
(10) Pub. No.: US 2005/0107112 A1
(43) Pub. Date: May 19, 2005

(54) Apparatus, and an associated method, for creating and using a call-screening list to screen calls placed to a communication station

(76) Inventor: Douglas Deeds, Bedford, TX (US)

Correspondence Address: Robert H. Kelly;Scheef & Stone, L.L.P., Suite 1400, 5956 Sherry Lane, Dallas, TX, 75225, US

(21) Appl. No.: 10/715,202

(22) Filed: Nov. 17, 2003

(51) Int. Cl. H04M 1/00

(52) U.S. Cl. 455/550.1

(57) ABSTRACT

Apparatus, and an associated method, for creating and using a call-screening list at a radiotelephone. The call-screening list is formed by making use of entries contained in a speed-dialing list also maintained at the radiotelephone. A user of the radiotelephone elects to create the call-screening list based upon the entries of the speed-dialing list. The entries contained in the speed-dialing list are accessed and copied into a call-screening list to form the entries thereof. When a call is subsequently placed to the radiotelephone, the identity of the calling station is determined and the identity of the calling station is compared with the entries in the call-screening list. If a match is found, then an alert is generated to alert the user of the radiotelephone of the terminating call.

The present invention relates generally to a manner by which to screen a terminating call delivered to a communication station, such as a radiotelephone operable in a cellular communication system. More particularly, the present invention relates to apparatus, and an associated method, by which to create a call-screening list and to use the call-screening list to screen calls that are placed to the radiotelephone, or other, communication station.

The call-screening list is derived from a speed-dialing list that is already created and maintained at the communication station. The user need not re-enter the dialing numbers together with their identifying indicia, already stored at the communication station, as part of the speed dialing list, a lengthy and error-prone process. Instead, selection is made merely to use the contents of the speed-dialing list as a call-screening list. Only limited user-entry by way of, e.g., an actuation keypad, is required to make the selection. Call screening, such as to permit only calls originated at calling stations identified in the speed-dialing list to be annunciated at the communication station for call-acceptance by a user of the communication station, is provided.

### BACKGROUND OF THE INVENTION

A communication system operates to communicate data between a sending station and a receiving station by way of a communication channel. A radio communication system is a communication system in which the communication channel upon which the data is communicated between the sending and receiving stations is defined upon a radio link, a portion of the electromagnetic spectrum. And, a cellular communication system is an exemplary type of radio communication system.

Radio communication systems do not require a fixed, wireline connection between communication stations, i.e., the sending and receiving stations, for data to be communicated between the communication stations. Radio communication systems are advantageously utilized, therefore, when communications are to be effectuated between locations at which formation of wireline connections would be inconvenient or impractical. Also, by obviating the need for wireline connections by which to communicate the data, a radio communication system is amenable for implementation as a mobile communication system. A cellular communication system provides for communication mobility in which communication stations operable therein are permitted mobility.

A cellular communication system provides for two-way telephonic communication, analogous to the telephonic communication conventionally permitted pursuant to a conventional, wireline telephonic system. That is to say, a radiotelephone operable in a cellular communication system is used to originate a call, or to terminate a call, in a manner analogous to a manner by which a conventional, wireline telephone is used to originate or to terminate a call.

To originate a call, a user of the radiotelephone enters, by way of a telephonic actuation keypad, the digits forming a telephone number of another telephonic station. When the radiotelephone is used to originate a call, the radiotelephone is referred to as the originating station or calling station, and the telephonic station to which the call is placed is referred to as the terminating station or called station. Once entered, the telephonic number is sent by way of a radio communication channel to a network part of the cellular communication system. The network part of the cellular communication system is, in turn, connected to an external telephonic network, such as a public-switched telephonic network. And, a call request associated with the call origination is routed through the telephonic network for delivery to the terminating station. If the call request is accepted, subsequent call set-up procedures are carried out, and a call connection is effectuated between the radiotelephone forming the originating station and the terminating station. Telephonic communication between the originating and terminating stations then ensues. The terminating station comprises a telephonic device, such as a wireline telephonic station or another radiotelephone.

A call is terminated at the radiotelephone in an analogous, but reverse, procedure. Another telephonic station, forming an originating station, is used at which to enter a telephonic identifier, i.e., the telephone number, associated with the radiotelephone. The radiotelephone to which the call is placed forms the terminating station. The call request initiated pursuant to entry at the originating station of the telephonic identifier identifying the radiotelephone is routed through the telephonic network and the network part of the cellular communication system, and then transmitted upon a radio channel defined upon a radio air interface of the cellular communication system for delivery to the radiotelephone. If the call request is accepted at the radiotelephone, call set-up procedures are carried out, and a communication connection is formed between the originating and terminating stations. Telephonic communication thereafter ensues.

If a call request is not accepted at the radiotelephone, the call request is terminated, or the call request is routed elsewhere, e.g., to a store-and-forward location that permits a message to be left by the user of the calling station.

Many radiotelephones are of small physical dimensions. The radio circuitry of such radiotelephones, together with a portable power supply, are regularly housed at, and within, a handset housing that is easily carriable by a user of the radiotelephone. That is to say, the radio transceiver circuitry used to send and receive data, acoustic, or other, transducers, i.e., a telephonic handset and a telephonic speaker, and a user actuator are all positioned at the handset housing.

The mobility provided by a radiotelephone and the ease at which a radiotelephone is carried by a user permits the user to place calls, and be called, from almost any location in an area encompassed by a cellular communication system. While the accessibility to communicate telephonically is generally advantageous, a user of a radiotelephone might sometimes want not to be alerted to terminating calls or at least terminating calls originated by certain callers. Or, in other words, the user of the radiotelephone might, at times, want to be alerted only to delivery of terminating calls placed by selected calling stations. To this end, some radiotelephones provide for the creation of call screening lists, sometimes referred to as caller groups. Family groups, VIP (very important person) groups, friends groups, business groups, etc. are all exemplary groups that are sometimes created and used at the radiotelephone for screening purposes. When a call request is delivered to the radiotelephone to terminate a call thereat, the identity of the calling station is compared with the telephonic identities contained in such screening list or lists. If the identity of the calling station corresponds to a telephonic identity contained in the list, the call request is accepted and call connection procedures continue. The delivery of the call is alerted, or otherwise annunciated, and the user of the radiotelephone decides whether or not to accept the call.

A call screening list is customizable by the user of the radiotelephone. Generally, the user is permitted to form a list of any selected number of telephonic identifiers, at least up to a maximum number, of telephonic identifiers into a call screening list. And, separate call screening lists are sometimes also formable.

However, when the call list is entered at the radiotelephone by way of the telephonic actuation keypad, a series of keypad actuations is required to create the list. Typically, both the telephonic identifier and an alpha-numeric identifier associated with the telephonic identifier are entered to form the list. When the list has a large number of entries, the creation of the list becomes a difficult and time-consuming task. The user must correctly enter the information to be listed in the screening list so that a terminating call is properly screened.

Some radiotelephones also include speed-dialing lists that permit a call to be originated at the radiotelephone through entry of only a single, or a few, commands by way of the user actuation keypad, or other actuator. Such numbers are typically numbers that the user of the radiotelephone frequently calls.

As there generally is a positive correlation between the speed-dialing list and a call-screening list, if a manner could be provided by which to utilize the telephonic identifiers contained in the speed-dialing list to be used for call-screening purposes, a call-screening list could be created without the burdensome task of entering the same information multiple times by way of the telephonic keypad.

It is in light of this background information related to call screening of calls terminated at a communication station, such as a radiotelephone operable in a cellular communication system,. that the significant improvements of the present invention have evolved.

### SUMMARY OF THE INVENTION

The present invention, accordingly, advantageously provides apparatus, and an associated method, by which to screen a terminating call delivered to a communication station, such as a radiotelephone operable in a cellular communication system.

Through operation of an embodiment of the present invention, a manner is provided by which to create a call-screening list and to use the call-screening list to screen calls that are placed to the radiotelephone, or other communication station. A speed-dialing list is maintained at the radiotelephone. The speed-dialing list includes telephonic identifiers, and other indicia, permitting a call to be originated by the radiotelephone through actuation by the user of the radiotelephone of only a single, or a few, actuation keys. The telephonic identifiers, and other information, contained in the speed-dialing list is used to create a call-screening list. That is to say, the call-screening list is derived from the speed-dialing list.

The user of the radiotelephone need not re-enter the dialing numbers, or other information, already stored at the radiotelephone as part of the speed-dialing list. Instead, the user selects to use the contents of the speed-dialing list as a call-screening list. Terminating calls terminated at the radiotelephone are screened against the call-screening list formed of the telephonic identifiers that are also contained in the speed-dialing list. If a terminating call is originated by a calling station that is identified in the speed-dialing list and, hence, also the call-screening list, the radiotelephone annunciates the call request to permit the user of the radiotelephone to accept the call. If, conversely, the call is originated by a calling station whose telephonic identifier is not contained in the list, the call request is handled in a different manner, such as by a call rejection or rerouting to a store-and-forward location.

Because the information already entered at, and contained at, the radiotelephone is used to form the call-screening list, only limited user entry by the user of the radiotelephone to form the call-screening list is required. Call screening, such as to permit only calls originated at calling stations identified in the speed-dialing list to be annunciated at the communication station for call acceptance by the user of the radiotelephone is provided. The multiple number of user keypad actuations to form the call-screening list is significantly reduced while conventional manners by which to create a call-screening list require two or more dozen keystroke actuations by a user to form each entry of a call-screening list, and dozens of keystroke entry actuations to form a multiple-entry screening list, creation of the call-screening list pursuant to an embodiment of the present invention requires only several, e.g., two or three, keystroke actuations to form the list.

In one aspect of the present invention, a user of the radiotelephone elects to create the call-screening list with the indicia already stored at the radiotelephone as part of a speed-dial memory. The user selects such creation through actuation of an appropriate actuation key of the radiotelephone, such as in conjunction with a screen menu option. Upon such selection, the contents of the speed-dial memory are accessed. And, once accessed, the contents are copied to form a call-screening list. In one implementation in which the radiotelephone utilizes a removable storage element, such as a SIM (Subscriber Identification Module), the speed-dial memory and the call-screening list are each stored at the SIM card. In another implementation, the speed-dial list and the call-screening list are stored elsewhere at the radiotelephone. Once created, the call-screening list is accessed when a terminating call is delivered to the radiotelephone. The contents of the call screening list are compared with the telephonic identifier that identifies the calling station at which the terminating call is originated. If the telephonic identifier of the calling station corresponds with a telephonic identifier contained in the call-screening list, call set-up procedures continue, and the user of the radiotelephone is alerted of the terminating call. In one implementation, the alert forms an aural annunciation together with a display on a user display of an alpha-numeric identifier identifying the calling station.

Because the call-screening list is easily created, call screening of calls is easily implemented at a radiotelephone.

In these and other aspects, therefore, apparatus, and an associated method, is provided for a radiotelephonic device. The radiotelephonic device is operable in a radiotelephonic communication system. Selectable call screening of a terminating call placed by a calling station and delivered to the radiotelephonic device is facilitated. A calling group listing is formed. The calling group listing is formed of a first-group set of dialing numbers. The first-group set of dialing numbers corresponds to a speed-dial set of dialing numbers selectably used at the radiotelephonic device pursuant to a speed-dialing procedure. A comparator is adapted to receive indications of the terminating call delivered to the radiotelephonic device together with an originating dialing number associated therewith and to the calling group listing. The comparator compares the originating dialing number with the first group set of dialing numbers and for determining whether the originating dialing number matches any of the first group set of dialing numbers. A call acceptor is adapted to receive indications of determinations made by the comparator. The call acceptor accepts the terminating call when the comparator determines the originating dialing number to match any of the first-group set of dialing numbers.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a radio communication system having a communication station operable pursuant to an embodiment of the present invention.

FIG. 2 illustrates a partial method flow, partial message sequence, diagram representative of operation of an embodiment of the present invention.

FIG. 3 illustrates a method flow diagram listing the method steps of the method of operation of an embodiment of the present invention.

### DETAILED DESCRIPTION

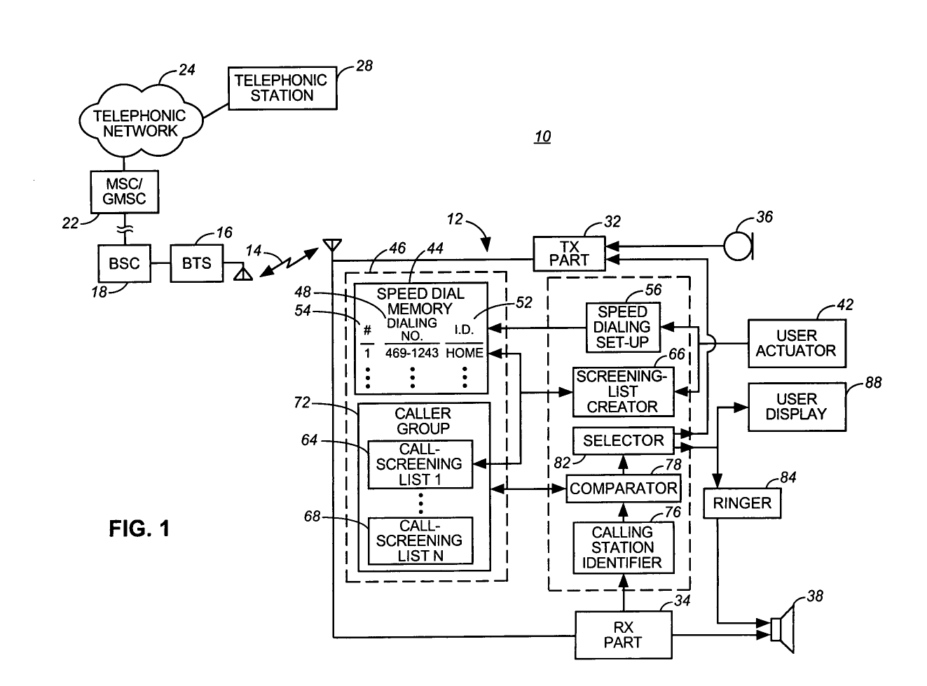

Referring first to FIG. 1, a radio communication system, shown generally at 10, provides for radio communications with mobile communication stations, of which a radiotelephone 12 is here representative.. Two-way telephonic communications are permitted both to send data and to receive data during operation of the radiotelephone in the communication system. In the exemplary implementation, the radio communication system operates generally pursuant to the operating parameters set forth in an appropriate cellular communication system specification, e.g., a GSM (Global System for Mobile communications) communication system. The communication system is, more generally, also representative of other radio telephonic communication systems, including cellular communication systems operable pursuant to other operating standards. While the following description shall describe exemplary operation of an embodiment of the present invention with respect to its implementation in a GSM cellular communication system, it should be understood that the teachings of the present invention are analogously applicable in other types of radiotelephonic communication systems.

Communications with the radiotelephone are effectuated by way of radio channels formed upon radio links defined pursuant to a radio air interface formed between the radiotelephone and a network part of the communication system. Here, the radio link, and the radio channels formed thereon, is represented by the arrow 14. Downlink channels are defined upon which to send downlink data. And, uplink channels are defined thereon upon which to communicate uplink data originated at the radiotelephone to the network part of the communication system.

The network part of the communication system is here shown to include a base transceiver station 16. The base transceiver station includes radio transceiver circuitry capable of communicating, i.e., both sending and receiving, downlink and uplink data. The base transceiver station defines a coverage area, referred to as a cell. When a radiotelephone, such as the radiotelephone 12, is positioned within such coverage area, radio communications between the radiotelephone and the base transceiver station that defines the cell are generally possible. Through appropriate positioning of a plurality of base transceiver stations at spaced-apart locations throughout an area in which radio communications are to be provided, continued communications with the radiotelephone are permitted as the radiotelephone travels between successive ones of the cells defined by successive ones of the base transceiver stations.

The base transceiver station is, in turn, coupled to a base station controller (BSC) 18. A base station controller is typically coupled to a group of base transceiver stations and operates to provide various control functions over the operations of the base transceiver stations to which the base station controller is coupled. And, the base station controller, in turn, is coupled to a mobile switching center/gateway mobile switching center (MSC/GMSC) 22. The MSC/GMSC forms a switch or gateway as appropriate, to an external network.

Here, the MSC/GMSC is coupled to a telephonic network 24. The telephonic network is representative of, e.g., a public-switched, telephonic network (PSTN) or a packet data network (PDN). Telephonic stations, such as the telephonic station 28, are coupled to the telephonic network. Telephonic communications are effectuable between the telephonic station 28 and the radio telephone 12 through the formation of communication connections between the telephonic station and the radiotelephone. The communication connection is formed through the network part of the communication system and by way of the radio air interface extending between the network part and the radiotelephone.

A call connection is originated by either the telephonic station 28 or the radiotelephone 12. For instance, a user of the radiotelephone 12 originates a call thereat for termination at the telephonic station 28 by entering the telephonic identifier associated with the telephonic station 28 and initiating a call thereto. The telephonic identifier associated with the telephonic station 28 is sent upon radio channels to the network part of the communication system and routed through the telephonic network 24 to be delivered to the telephonic station 28. When a user of the telephonic station 28 accepts the call, call connection procedures are carried out and call connections are formed between the radiotelephone and the telephonic station, and telephonic communications ensue.

Analogously, a call originated by a user of the telephonic station 28 for termination at the radiotelephone 12 is initiated by entering the telephonic identifier associated with the radiotelephone. A call request is routed through the telephonic network and the network part of the cellular communication system and then sent upon the radio channel to be delivered to the radiotelephone. If the call is accepted at the radiotelephone, call connections are formed between the telephonic station and the radiotelephone. And, upon formation of the call connections, telephonic communication between the telephonic station and the radiotelephone commences.

The radiotelephone also includes radio transceiver circuitry, here identified by a transmit part 32 and a receive part 34. The transmit part is here further shown to be coupled to a speech transducer 36, e.g., a microphone, and the receive part is shown to be coupled to an acoustic transducer 38, e.g., a speaker.

When a call is to be originated at the radiotelephone, a user of the radiotelephone initiates the call origination through appropriate actuation of a user actuator 42 of the radiotelephone. The user actuator forms a telephonic keypad, or other appropriate actuation apparatus. The telephonic identifier identifying the telephonic station forms a sequence of dialing digits, i.e., the telephone number associated with the telephonic station 28. Here, the radiotelephone includes a speed-dial memory 44 embodied at a memory element 46. In one implementation, the memory is a fixed memory embodied at the radiotelephone. In another implementation, the radiotelephone includes a removable memory element, e.g., a SIM (subscriber identification module) and the memory locations are embodied at the SIM (Subscriber Identifier Module) of the mobile station. The speed-dial memory includes a listing of dialing numbers 48 together with alpha-numeric identifiers 52 associated therewith. Each entry in the speed-dial memory is further identified by a listing number 54.

The speed-dial memory is created through user input, such as by way of the user actuator 42 in conjunction with a speed-dialing set-up procedure 56 here implemented at a controller 58. Once the speed-dial memory is created, a call placed to a telephonic station identified by any of the dialing digits contained in the entries of the speed-dialed memory, is initiated through entry of an abbreviated number of digits. Here, for instance, when the speed-dial memory is accessed, a call is initiated through entry of a listing number, or otherwise through selection of the listing number. That is to say, when speed-dialing procedures are utilized, the entire sequence of dialing digits associated with the terminating station need not be entered by the user of the radiotelephone. Rather, the call is initiated more speedily through retrieval of a number from the speed-dial memory and transmission of the retrieved number pursuant to the calling procedures.

As noted previously, the communication mobility provided through the use of radio communications and the minimal physical dimensions of the radiotelephone permit the radiotelephone easily to be hand-carried by the user thereof, readily available to originate and to receive calls when the user is positioned at almost any location encompassed by the radio communication system. The user, however, might not want to be alerted to the delivery to the radiotelephone of all call requests delivered thereto. Call screening of the terminating calls is sometimes desired to screen the calls and to alert the user of only the calls originated by telephonic stations that meet selected call-screening criteria. While formation of call-screening lists is permitted, their creation and entry by way of the telephonic keypad forming the user actuator 42 is sometimes too time-consuming for a user. And, the call-screening list is not created.

The radiotelephone 12 operates pursuant to an embodiment of the present invention to facilitate formation of a call-screening list that requires only minimal input by a user by way of the user actuator 42. Advantage is taken of the speed-dial memory 44, and the contents thereof, to provide the telephonic identifiers that form entries of a call-screening list.

Pursuant to an embodiment of the present invention, a call-screening list 64 is created pursuant to a call-screening list creator procedure 66, here embodied at the controller 58. The procedure is carried out responsive to user initiation by way of actuation of an appropriate actuation key of the user actuator 42. Once initiated, the contents of the speed-dial memory 44 are accessed and copied to form the call-screening list 64. In the exemplary implementation, at least the dialing number and the alpha-numeric identifier associated with the dialing number of each entry contained in the speed-dial memory is copied to form a corresponding entry in the call-screening list. In another implementation, the user is prompted to select, on an entry-by-entry basis, whether to incorporate the speed-dial memory entry into the call-screening list. Additionally, in the exemplary implementation, the call-screening list 64 is embodied at the memory element 46, again, for instance, selected memory locations of an SIM card.

Additional call-screening lists are formable, including call-screening lists formed in a conventional manner. Here, an Nth call-screening list 68 is also embodied at the memory element. The call-screening lists 64 and 68 together form a caller group 72.

Once created, the call-screening list 64 is utilized selectively to screen calls originated elsewhere for termination at the radiotelephone. Because the call-screening list is created by utilizing entries stored in the speed-dial memory, the number of user actuations required of the user to form the call-screening list is limited, permitting improved ease of call-screening list formation.

Once the call-screening list 64 is formed, access to the entries of the call-screening list is made to screen terminating calls placed to the radiotelephone.

When a call is originated at the telephonic station 28 for termination at the radiotelephone 12, the telephonic identifier associated with the radiotelephone is entered at the telephonic station and a call request is generated. The call request includes indicia associated with the telephonic identifier of the telephonic station 28. The call request is routed through the telephonic network, the network part of the cellular communication system, and over the radio air interface for delivery to the radiotelephone. The receive part 34 of the radiotelephone detects the call request. And, a calling station identifier procedure 76 identifies the telephonic identifier of the originating telephonic station 28. The telephonic identifier is provided to the comparator 78. And, the comparator accesses the entries on the call-screening list 64 and compares the values of the telephonic identifiers contained thereat with the received telephonic identifier of the originating telephonic station. Results of the comparisons made by the comparator are provided to a selector 82. The selector selects whether to permit the call request to be alerted at the radiotelephone. If a determination is made by the comparator that the telephonic identifier of the originating station corresponds with a telephonic identifier contained in the call-screening list, the terminating call is alerted, here by actuating a ringing function by the ringer 84 that causes the acoustic transducer to generate an audible alert. If no match is made, conversely, the selector causes the transmit part 32 to generate a call reject message so that the call is rejected and treated as unanswerable. When the terminating call is annunciated, the user of the radiotelephone selects whether to accept the call. If the user elects to accept the call, a call connection is formed, and telephonic communications commence. The selector, in one implementation, also causes the telephonic identifier of the terminating call to be displayed on-the user display 88.

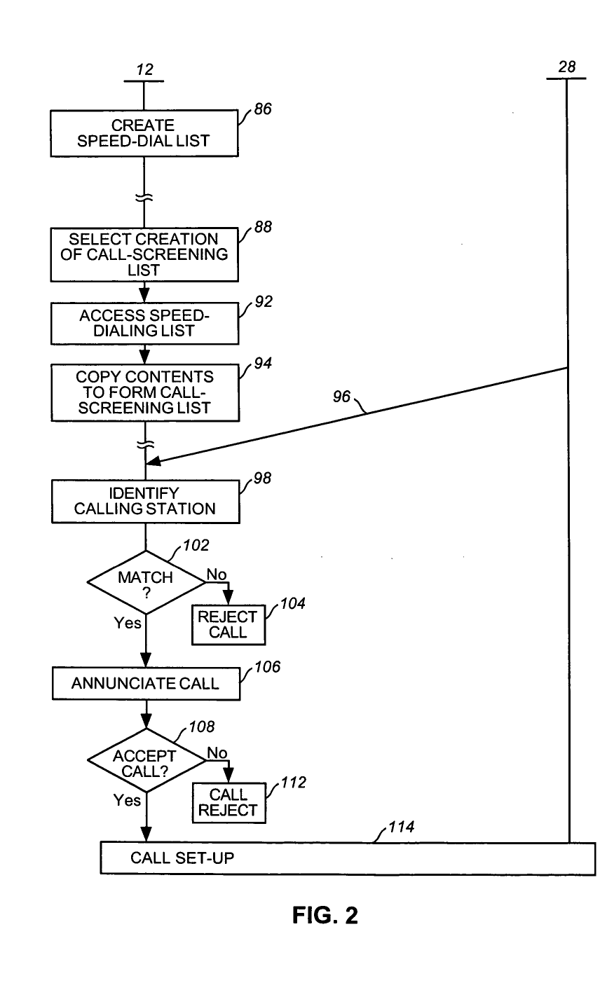

FIG. 2 illustrates a message sequence diagram, shown generally at 84, representative of operation of an embodiment of the present invention. Here, the radio telephone 12 forms a terminating station, and the telephonic station 28 forms the originating station.

First, and as indicated by the block 86, the speed dial list is created and maintained at the radiotelephone. Subsequent to its creation, the user of the radiotelephone elects to create a call-screening list, indicated by the block 88, through appropriate actuation of the user actuator (shown in FIG. 1) of the radiotelephone. The screening list creator procedure is invoked, and the entries of the speed-dialing list are accessed, indicated by the block 92. And, the contents that are accessed are copied, indicated by the block 94, to form the call-screening list. Thereafter, when a call originated at the telephonic station 28 is communicated, as indicated by the segment 96, to the radiotelephone in the form of a call request, the call request is detected, and the identity of the calling station is determined, as indicated by the block 98.

A determination is made, indicated by the decision block 102, as to whether the identity of the calling station corresponds with an entry on the call-screening list. If not, the “no” branch is taken and the call is rejected, indicated by the block 104. Otherwise, the “yes” branch is taken to the block 106, and the call is annunciated.

The user of the radiotelephone elects whether to accept the call, indicated by the decision block 108. If the call is not accepted, the “no” branch is taken to the block 108 and the call is rejected. Otherwise, the “yes” branch is taken-and call set-up procedures are carried out, as indicated by the block 114.

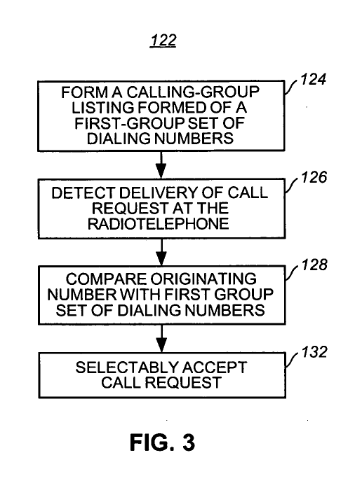

FIG. 3 illustrates a method flow diagram, shown generally at 122, representative of the method of an embodiment of the present invention. The method facilitates selectable call screening of a terminating call placed by a calling station and delivered to the radiotelephone.

First, and as indicated by the block 124, a calling group listing is formed. The calling group listing is formed of a first-group set of dialing numbers. The first-group set of dialing numbers corresponds to a speed-dial set of dialing numbers selectably used at the radiotelephone pursuant to a speed-dialing procedure.

Then, and as indicated by the block 126, delivery of a call request to terminate a call at the radiotelephone is detected. The call request includes an originating dialing number of the calling station at which the call is originated. Then, and as indicated by the block 128, the originating dialing number is compared with the first-group set of dialing numbers. A determination is made whether the originating dialing number matches any of the first-group set of dialing numbers. And, as indicated by the block 132, the call request is selectively accepted when determination is made that the originating dialing number matches any of the first-group set of dialing numbers.

Thereby, a manner is provided by which to form a call-screening list and subsequently use the call-screening list to screen calls placed to the radiotelephone. The call-screening list is created in a manner requiring only limited user input at the radiotelephone.

The previous descriptions are of preferred examples for implementing the invention, and the scope of the invention should not necessarily be limited by this description. The scope of the present invention is defined by the following claims.

1. In a radiotelephonic device operable in a radiotelephonic communication system, an improvement of user interface apparatus for facilitating selectable call screening of a terminating call placed by a calling station and delivered to the radiotelephonic device, said user interface apparatus comprising:
a calling-group listing formed of a first-group set of dialing numbers, the first-group set of dialing numbers corresponding to a speed-dial set of dialing numbers selectably used at the radiotelephonic device pursuant to a speed dialing procedure;
a comparator adapted to receive indications of the terminating call delivered to the radiotelephonic device together with an originating dialing number associated therewith and to said calling-group listing, said comparator for comparing the originating dialing number with the first-group set of dialing numbers and for determining whether the originating dialing number corrresponds with the first-group set of dialing numbers and for determining whether the originating dialing number matches any of the first-group set of dialing numbers; and
a call acceptor adapted to receive indications of determinations made by said comparator, said call acceptor for selectably accepting the terminating call when said comparator determines the originating dialing number to match any of the first-group set of dialing numbers.

2. The apparatus of claim 1 further comprising an annunciator adapted to receive indications of call acceptance by said call acceptor, said annunciator for selectably annunciating the terminating call in a selected manner when the terminating call is accepted by said call acceptor.

3. The apparatus of claim 2 wherein said annunciator comprises an aural annunciator, and wherein said aural annunciator selectably annunciates the terminating call with an aural sequence of sounds.

4. The apparatus of claim 3 wherein the aural sequence of sounds is annunciated by said aural annunciator when said comparator determines the originating dialing number to match any of the first group set of dialing numbers of said calling group listing.

5. The apparatus of claim 1 wherein the radiotelephonic device comprises a removable memory element and wherein said calling-group listing is formed at the removable memory element.

6. The apparatus of claim 5 wherein the speed-dial set of dialing numbers is further formed at the removable memory element.

7. The apparatus of claim 1 further comprising a calling-group listing creator adapted to receive indications of the speed-dial set of dialing numbers, said calling-group listing creator for creating said calling-group listing.

8. The apparatus of claim 7 wherein the radiotelephonic device comprises a memory element and wherein said calling-group listing, once created by said calling-group listing creator, is stored by said calling group listing creator at the memory element.

9. The apparatus of claim 7 wherein the radiotelephonic device further comprises a user actuator, said calling-group listing creator further adapted to receive selected input actuations generated by the user actuator and wherein said calling-group listing creator operates to create said calling-group listing responsive to reception of the selected input actuations.

10. The apparatus of claim 7 wherein said calling group listing creator creates said calling-group listing by copying the speed-dial set of dialing numbers.

11. The apparatus of claim 1 wherein the originating dialing number comprises a sequence of digits, wherein each dialing number of said calling-group listing also comprises a sequence of digits and wherein said comparator compares values of the digits forming the originating dialing number with corresponding digits of each dialing number of said calling-group listing.

12. The apparatus of claim 1 wherein the radiotelephonic device further comprises a user display and wherein, upon acceptance of the terminating call by said call acceptor, values representative of the originating dialing number, are caused by said call acceptor to be displayed on the user display.

13. The apparatus of claim 12 wherein said calling-group listing further comprises an alpha-numeric identifier associated with each of the dialing numbers of the first-group set forming said calling-group listing and wherein the values representative of the originating dialing number comprises the alphanumeric identifier associated with the dialing number determined by said comparator to match the originating dialing number.

14. The apparatus of claim 1 wherein said call acceptor is further adapted to receive indications of determinations of said comparator that the originating dialing number fails to match any of the first-group set of dialing numbers, said call acceptor further selectably for generating a call-reject command.

15. In a method for communicating in a radiotelephonic communication system having a radiotelephone, an improvement of a method for facilitating selectable call screening of a terminating call placed by a calling station and delivered to the radiotelephone, said method comprising:
forming a calling-group listing comprised of a first-group set of dialing numbers, the first-group set of dialing numbers corresponding to a speed-dial set of dialing numbers selectably used at the radiotelephone pursuant to a speed dialing procedure;
detecting delivery of a call request to terminate a call at the radiotelephone, the call request including an originating dialing number at which the call is originated;
comparing the originating dialing number with the first-group set of dialing numbers to determine whether the originating dialing number matches any of the first-group set of dialing numbers; and
accepting the call request when determination is made during said operation of comparing that the originating dialing number matches any of the first-group set of dialing numbers.

16. The method of claim 15 further comprising the operation of annunciating the call request.

17. The method of claim 15 wherein the speed-dial set of dialing numbers is stored at the radiotelephone and wherein said operation of forming the calling-group listing comprises accessing indications of the speed-dial set of dialing numbers.

18. The method of claim 17 wherein said operation of forming further comprises copying the speed-dial set of dialing numbers.

19. The method of claim 15 wherein the calling-group listing formed during said operation of forming is stored at a removable memory element of the radiotelephone.

20. The method of claim 18 wherein the radiotelephone further comprises a user actuation and wherein said operation of copying is performed responsive to selected actuation of the user actuator.
